(19) United States
(12) Patent Application Publication
(10) Pub. No.: US 2016/0198391 A1
(43) Pub. Date: Jul. 7, 2016

(54) SYSTEM AND METHOD FOR COMMUNICATING DATA

(71) Applicant: AGFA HEALTHCARE, Bonn (DE)

(72) Inventors: Marc-Andre ORTHMANN, Mortsel (BE); Martin REITSTAETTER, Mortsel (BE)

(21) Appl. No.: 14/909,481

(22) PCT Filed: Aug. 26, 2014
(86) PCT No.: PCT/EP2014/068032

§ 371 Date: Feb. 2, 2016

(30) Foreign Application Priority Data
Aug. 28, 2013 (EP) 13182004.5

(51) Int. Cl. H04W 40/24; H04L 12/741; H04W 72/04

(52) U.S. Cl. CPC H04W 40/248; H04W 72/0406; H04L 45/74

(57) ABSTRACT

A system and a method for communicating data between a central module and a peripheral module includes the steps of determining a first communication port from at least one first port of the central module, the first communication port being currently available for transmitting and receiving data; displaying a first port identification code identifying the determined first communication port on a display of the central module; scanning the first port identification code displayed on the display of by the central module by a code scanner of a peripheral module; and transmitting a unique second port identification code identifying a second communication port of the peripheral module from the second communication port of the peripheral module to the determined first communication port of the central module. It is possible to pair the central module and the peripheral module from at least one peripheral module in an easy and fast manner.

### CROSS-REFERENCE TO RELATED APPLICATIONS

This application is a 371 National Stage Application of PCT/EP2014/068032, filed Aug. 26, 2014. This application claims the benefit of European Application No. 13182004.5, filed Aug. 28, 2013, which is incorporated by reference herein in its entirety.

### BACKGROUND OF THE INVENTION

1. Field of the Invention

The invention relates to a system and a method for communicating data between a central module and a peripheral module, in particular in a wireless manner.

2. Description of the Related Art

In many applications, a user collects data encoded in barcodes by scanning the barcodes with a mobile device. The scanned barcodes are usually processed and stored in a central module at the user's workplace (e.g. a computer, a workstation, etc.). For this purpose, the mobile device has to transmit the data of the scanned barcodes to the central module by addressing a known port of a known IP address of the central module, for example, via cable link or WLAN.

For example, in an operating room equipped with WLAN consumables are detected by surgical documentation software. The software runs on a computer placed in the operating room and is controlled by the nursing staff. If an item is scanned, a corresponding entry in the surgical documentation software is created. For this purpose, the mobile scanning device must know the IP address and the corresponding port of the associated central module, so that it can transmit the scanning result directly to the central module. However, both the IP address and the port may change when the central module is restarted.

### SUMMARY OF THE INVENTION

Preferred embodiments of the invention provide an improved system and method for communicating data between a central module and at least one peripheral module, which allow for establishing a data link between the central module and the at least one peripheral module in an easy and fast manner.

The system for communicating data between a central module and at least one peripheral module according to the invention comprises a central module and at least one peripheral module. The central module comprises at least one first port being adapted for transmitting and receiving data, and a display being adapted for displaying a first port identification code identifying a first communication port out of the at least one first port, the first communication port being currently available for transmitting and receiving data. The at least one peripheral module comprises a code scanner being adapted for scanning the first port identification code displayed on the display of the central module, and a second port as a second communication port being adapted for transmitting and receiving data and having a unique second port identification code, wherein the at least one peripheral module is configured to transmit the second port identification code to the first communication port of the central module via the second communication port.

The method for communicating data between a central module and a peripheral module according to a preferred embodiment of the invention comprises the steps of determining a first communication port out of at least one first port of a central module, the first communication port being currently available for transmitting and receiving data; displaying a first port identification code identifying the determined first communication port on a display of the central module; scanning the first port identification code displayed on the display of the central module by a peripheral module; and transmitting a unique second port identification code identifying a second communication port of the peripheral module from the second communication port of the peripheral module to the determined first communication port of the central module.

The invention is based on the approach to display the communication address of the central module (i.e. IP address and currently available port) on a display of the central module and to scan this information by a code scanner of a peripheral module currently used by a user. In this way, the code scanner being adapted for reading codes of items and the like can also be used for reading the communication address or other relevant communication parameters of the central module. On the other hand, the unique second port identification code identifying the second communication port of the peripheral module is transmitted from the second communication port of the peripheral module to the first communication port of the central module. In this way, the second communication port of the peripheral module being adapted for transmitting code data corresponding to scanned codes to the central module can also be used for transmitting the communication address of the peripheral module to the known communication address of the central module.

In summary, an easy and fast pairing of the central module and one of its ports being currently available, on the one hand, with the peripheral module and its port, on the other hand, can be achieved, in particular with a simple construction of the central and peripheral modules. In particular, the pairing process can also be carried out in easy and fast manner when restarting the central module which may result in changed communication parameters. Within the meaning of the present invention the term “pairing” is used synonymously with the term “establishing a data link”.

In particular, the central module comprises a number of first ports, i.e. two or more first ports, and is configured to determine, out of the number of first ports, a first communication port being currently available for communication with the peripheral module and to assign a corresponding port number to the determined first communication port. The central module is configured to control the display such that the first port identification code including the port number of the determined first communication port is displayed on the display. The displayed first port identification code including the port number of the determined first communication port can be scanned by the code scanner of the peripheral module. By this, the peripheral module is enabled to transmit data over its communication port to the determined first communication port of the central module. As a result, the central module can be paired with an arbitrary number of peripheral modules in an easy, fast and reliable manner. The total number of peripheral modules that can be simultaneously paired with the central module is only limited by the number of the first ports of the central module.

The system and method of the invention can preferably be used in a healthcare environment, like a hospital information system (HIS), especially for documentation and administration tasks.

The codes to be scanned by the code scanner of the at least one peripheral module are preferably one or two-dimensional optically readable codes, such as barcodes.

According to a preferred embodiment of the invention, the first communication port of the central module and the second communication port of the at least one peripheral module are adapted for communicating (transmitting and receiving data) in a wireless manner. As a result, the central module and the at least one peripheral module can communicate with each other in a wireless manner. Preferably, the first and second communication ports of the central module and the at least one peripheral module are adapted for communicating with each other via a wireless Local Area Network (WLAN). Preferably, that WLAN conforms to the Transmission Control Protocol/Internet Protocol (TCP/IP) industry standard.

According to a preferred embodiment of the invention, the central module is configured to determine the first communication port out of the at least one first port, to receive the second port identification code of the peripheral module via the first communication port, and to transmit data to the second communication port of the peripheral module via the first communication port.

According to another preferred embodiment of the invention, the central module comprises or is connected to a memory being adapted for storing the first port identification code of the central module and the associated second port identification code of the peripheral module. For example, the first port identification code of the central module and the associated second port identification code of the peripheral module are stored in the form of a table. If there is a number of peripheral modules to communicate with the central module, the first port identification codes of the central module and the associated second port identification codes of the peripheral modules are stored in the memory.

According to another preferred embodiment of the invention, the at least one peripheral module comprises a memory being adapted for storing the first port identification code of the central module.

It is preferred that the first port identification code includes data referring to the IP address of the central module and data referring to the first communication port of the central module. It is also preferred that the second port identification code includes data referring to the IP address of the peripheral module and data referring to the second communication port of the peripheral module.

Further, it is preferred that the first port identification code includes instruction data indicating that the first port identification code is associated to the central module which the at least one peripheral module is to communicate with. It is also preferred that the second port identification code includes instruction data indicating that the second port identification code is associated to the peripheral module which the first communication port of the central module is to communicate with. With this configuration, the central module or the peripheral module, respectively, can recognize by the help of such instruction data that a pairing process is to be carried out, when receiving/scanning the corresponding first and second port identification codes.

According to a preferred embodiment of the invention, the at least one peripheral module comprises an outputting device being adapted for outputting information based on data received from the central module. Preferably, this outputting device is adapted for outputting information in an optical and/or acoustic manner. Accordingly, the outputting device preferably comprises a display and/or a speaker.

According to another preferred embodiment of the invention, the central module is adapted for transmitting acknowledgement data to the at least one peripheral module acknowledging successful receipt of data from the at least one peripheral module and/or the at least one peripheral module is adapted for transmitting acknowledgement data to the central module acknowledging successful receipt of data from the central module. With this configuration, especially a pairing process can be carried out in a reliable manner.

The above objects are further achieved by a peripheral module comprising a code scanner for reading a first port identification code displayed on a display of a central module, and being configured to be used in a system according to the invention as described above.

Furthermore, the above object are also achieved by a central module comprising a display for displaying a first port identification code identifying a first communication port out of the at least one first port, and being configured to be used in a system according to the invention as described above.

Further advantages, features and examples of the present invention will be apparent from the following description with reference to the accompanying drawings. In the drawings:

### BRIEF DESCRIPTION OF THE DRAWINGS

FIG. 1 shows a block diagram of an exemplary preferred embodiment of a system for communicating data;

FIG. 2 shows a diagrammatic chart of an exemplary preferred embodiment of a method for pairing a central module and a peripheral module which can be carried out, for example; by the system shown in FIG. 1; and

FIG. 3 shows a diagrammatic chart of communication procedures between the central module and the peripheral module of the system shown in FIG. 1 in more detail.

### DETAILED DESCRIPTION OF THE PREFERRED EMBODIMENTS

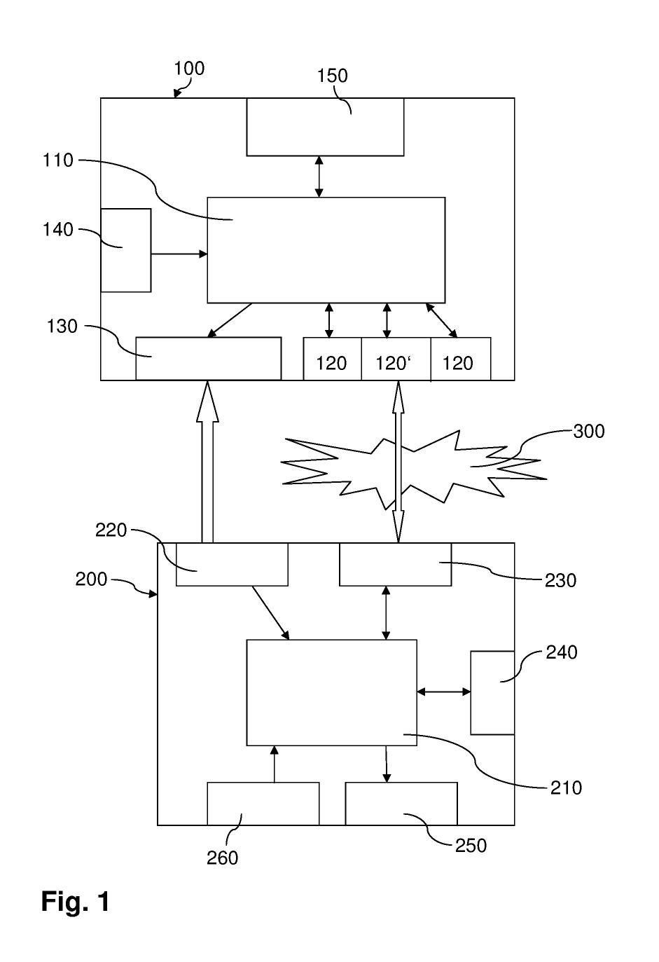

FIG. 1 shows an example of a system for communicating data between a central module and at least one peripheral module. The system comprises a central module 100, preferably being configured as a computer or workstation, and at least one peripheral module 200 (only one is shown exemplarily in FIG. 1), preferably being configured as a handheld or mobile device. This system preferably may be used in healthcare environments, like a HIS, for administration and documentation tasks.

The central module 100 comprises a processing device 110 comprising a microprocessor, for example. Especially, the processing device 110 is adapted for processing the data transmitted from the peripheral module 200 and generating the data to be transmitted to the peripheral module 200.

The processing device 110 is connected to a number of first ports 120 which may be connected to various devices. Some of the first ports 120 are adapted for transmitting and receiving data via cable link, some other first ports 120 are adapted for transmitting and receiving data in a wireless manner. Reference sign 120′ designates the first communication port of the central module 100 out of the first ports 120 which is currently available for transmitting and receiving data to/from the peripheral module 200 in a wireless manner. The first communication port 120′ is preferably adapted to communicate via a wireless Local Area Network (WLAN) 300 being in conformity with the Transmission Control Protocol/Internet Protocol (TCP/IP) industry standard.

When starting or restarting the central module 100, an IP address sIP is dynamically assigned to the central module 100, and the processing device 110 determines the first communication port 120′ being currently available for communication with the peripheral module 200 and assigns a corresponding port number sPort. Thus, the processing device 110 of the central module 100 can generate a first port identification code sID including the IP address sIP of the central module 100 and the port number sPort of the determined first communication port 120′.

As shown in FIG. 1, the processing device 110 of the central module 100 is further connected to a display 130. On this display 130, the central module 100 can output the first port identification code sID generated by the processing device 110. Especially, the first port identification code sID is displayed on the display 130 in the form of a one- or two-dimensional barcode which can be scanned by a code scanner.

Similar to conventional computers and workstations, the processing device 110 of the central module 100 is also connected to an inputting device 140 (keyboard, mouse, touchscreen, etc.).

As shown in FIG. 1, the central module 100 further comprises an internal memory 150. In an alternative preferred embodiment, the central module 100 is connected to an external memory. In this memory 150, the processing device 110 can store pairing information of the central module 100 and the at least one peripheral module 200 including first port identification codes sID of the central module 100 and second port identification codes cID of one or more peripheral modules 200 as described below.

The peripheral module 200 comprises a code scanner 220. This code scanner 220 is configured as an optical code scanner for reading one- or two-dimensional optically readable barcodes. The peripheral module 200 also comprises a processing device 210 comprising a microprocessor, for example. The processing device 210 is adapted for pre-processing the codes read by the code scanner 220, generating code data corresponding to the codes read by the code scanner 220, and generating a second port identification code cID described below. Also, the processing device 210 can judge whether the codes have been detected by the code scanner 220 correctly or not.

The processing device 210 is also connected to a port serving as a second communication port 230. This second communication port 230 is adapted to transmit and receive data to/from the first communication port 120′ of the central module 100 in a wireless manner. Similar to the first communication port 120′ of the central module 100, this second communication port 230 is adapted to communicate via a wireless Local Area Network (WLAN) 300 being in conformity with the Transmission Control Protocol/Internet Protocol (TCP/IP) industry standard.

Further, the peripheral module 200 comprises an internal memory 240 connected to the processing device 210. In this memory 240, the processing device 210 can store the IP address sIP of the central module 100 and the port number sPort of the determined first communication port 120′ of the central module 100 included in the first port identification code sID scanned by the code scanner 220. The peripheral module 200 needs this communication data for transmitting data from the second communication port 230 to the determined first communication port 120′ of the central module 100.

Further, the processing device 210 of the peripheral module 200 is connected to an outputting device 250, preferably comprising a display and/or a speaker for outputting messages in an optical or acoustic manner. Especially, the outputting device 250 may output messages corresponding to code data corresponding to codes scanned by the code scanner 220 or information data received by the second communication port 230 from the central module 100. These information data may include confirmation data as to whether the code data have been received and processed by the central module 100 successfully or not. Also, the outputting device 250 may output messages as to whether the codes have been read by the code scanner 220 successfully or not.

Furthermore, the processing device 210 of the peripheral module 200 is connected to an inputting device 260. This inputting device 260 may comprise a scanner button for initiating a scanning process of the code scanner 220, a confirmation button for confirming that the message outputted by the outputting device 250 has been read, and the like. The inputting device 260 may also be integrated with the outputting device 250, for example it may be configured as a touchscreen.

With the system shown in FIG. 1, an easy and fast pairing of the central module 100 and the peripheral module 200 can be achieved as follows.

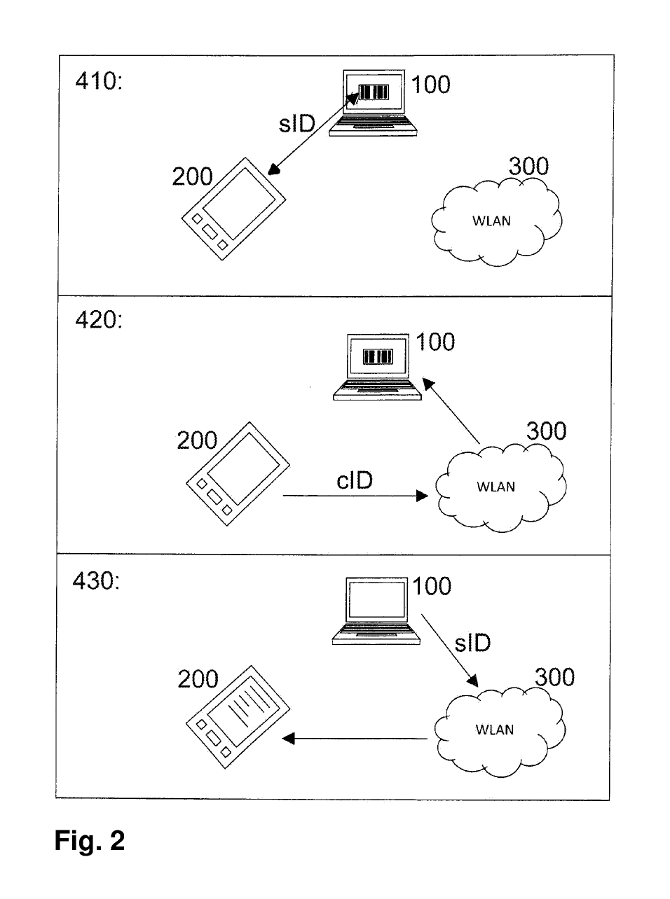

As shown in FIG. 2, in a first step 410 the processing device 110 of the central module 100 determines the first communication port 120′ out of the first ports 120 of the central module 100 which is adapted to communicate via WLAN 300 and is currently available. Then, the processing device 110 generates the corresponding first port communication code sID and displays a corresponding barcode on the display 130 of the central module 100. This first port communication code sID includes a prefix indicating a pairing process (instruction data), the IP address sIP and the determined first communication port sPort of the central module 100. This barcode is now scanned directly from the display 130 by the code scanner 220 of the peripheral module 200.

Due to the set up prefix of the first port communication code sID, in a second step 420 the processing device 210 recognizes that this code scanned by the code scanner 220 is a request for pairing the central module 100 and the peripheral module 200. As a result, the IP address sIP and the port number sPort included in the first code identification code sID are stored in the memory 240 of the peripheral module 200. Then, the peripheral module 200 transmits the second port identification code cID including a prefix indicating a pairing process (instruction data), the IP address cIP and the unique second communication port cPort of the peripheral module 200 via the second communication port 230 to the known first communication port 120′ of the central module 100.

In a third step 430 shown in FIG. 2, the IP address cIP and the port number cPort included in the second code identification code cID are stored in the memory 150 of the central module 100. Optionally, the central module 100 can now send a confirmation code to the peripheral module 200 that the pairing has been recognized by the central module 100 successfully.

With this system, a peripheral module 200 can be connected to/paired with just one central module 100, but a central module 100 can communicate with multiple peripheral modules 200, depending on the number and kind of the first ports 120 of the central module 100. The pairing data should be persistent, because the central and peripheral modules 100, 200 are turned on and off frequently, in general. Therefore, the above described pairing information is stored in the memory 150 of the central module 100 in the form of a table. That table may exemplarily have the following contents:

| | cen- | | | | | |
|---|---|---|---|---|---|---|
| | tral | | | periph- | | |
| | mod- | | | eral | | |
| ID | ule | sIP | sPort | module | cIP | cPort |
| 1 | AP1 | 192.168.1.100 | 49155 | Mobil1 | 192.168.2.101 | 50000 |
| 2 | AP1 | 192.168.1.100 | 49155 | Mobil2 | 192.168.2.108 | 50000 |
| 3 | AP3 | 192.168.1.106 | 49166 | Mobil3 | 192.168.2.161 | 50000 |
| . . . | | | | | | |

A peripheral module 200 is connected to a central module 100 as long as it is either actively disconnected or newly connected to another central module 100.

To implement the functionality explained above, two components are needed: a first (software) application running on the processing device 110 of the central module 100, and a second (software) application running on the processing device 210 of the peripheral modules 200.

In this preferred embodiment, the first (software) application running on the processing device 110 of the central module 100 has for example implemented the following functions:

showBarcode ( )

This function displays the first port identification code sID in the form of a barcode on the display 130 of the central module 100. As explained above, the first port identification code sID especially includes the IP address sIP of the central module 100, the port number sPort of the determined first communication port 120′ of the central module, as well as a prefix comprising instruction data doPairing being known to the processing device 210 of the peripheral modules 200. For example, the first port identification code sID may read as follows: doPairing#192.168.1.100:49155. In addition or alternatively to the known prefix doPairing, there may also be used a specific symbolism or notation (e.g. data matrix) known to the processing devices 110, 210 of both the central module 100 and the peripheral modules 200 of the system.

### Ack(cMessageID)

This function sends a confirmation message to the peripheral module 200 referring to a specific message code cMessageID. In this way, the peripheral module 200 can be informed that its message/request/command having this message code cMessageID has been received at the central module 100.

getsPort( )

This function provides a first communication port 120′ of the central module 100 being currently available for wireless communication. The first communication port 120′ may change after each restart of the central module 100, especially when using a Citrix environment. The dynamic port range is for example 49152-65535.

setServer(sIP,sPort,sMessageID)

When the IP address cIP of the peripheral module 200 and the port number cPort of the second communication port 230 of the peripheral module 200 are known to the central module 100, by sending this message setServer(sIP,sPort, sMessageID) to the peripheral module 200 the peripheral module 200 is informed that it shall set up its communication settings to include sIP and sPort. In addition, this message includes a message code identifier sMessageID identifying this message which can be recognized by the peripheral module 200 and used for acknowledging safe receipt of this message.

sendMessage(Text,sMessageID)

With this function, a formatted text is transmitted form the central module 100 to the peripheral module 200. This text may then be displayed or outputted by the outputting device 250 of the peripheral module 200. For example, the text is transmitted in HTML format and displayed in a web browser of the peripheral module 200. By the included message code identifier sMessageID the peripheral module 200 can explicitly confirm safe receipt and output of the transmitted text.

Further, the second (software) application running on the processing device 210 of the peripheral module 200 has for example implemented the following functions, in this preferred embodiment:

scanBarcode( )

The scanning of a barcode by the code scanner 220 may be initiated by pressing a corresponding scanner button of the inputting device 260 of the peripheral module 200. Pressing the scanner button calls up a corresponding function is called for carrying out the scanning process by the code scanner 220 and decoding the scanned barcode by the processing device 210. Afterwards, the present function makes sure that the further function sendBarcode ( . . . ) is called up in case the communication data for communicating with the central module 100 are already received from the central module 100.

doPairing(cIP,cPort,cMessageID)

This function sends a request for pairing to the central module 100 and transmits the IP address cIP of the peripheral module 200 and the port number cPort of the second communication port 230 of the peripheral module 200 to the central module 100. The processing device 110 of the central module 100 then stores these communication data in the above explained table in the memory 150. In addition, this message includes a message code identifier cMessageID identifying this message which can be recognized by the central module 100 and used for acknowledging safe receipt of this message to the peripheral module 200.

sendBarcode(Barcode,cMessageID)

This function sends the barcode scanned by the code scanner 220 and pre-processed by the processing device 210 including a message code identifier cMessageID to the central module 100 which can confirm the receipt of this message using this message code identifier. The processing device 110 of the central module 100 processes the barcode (processes of interpreting, classifying, etc.) and initiates corresponding actions or workflows, if needed. Such an action may be for example to call up the function sendMessage(Text, sMessageID) for displaying a message on the display 250 of the peripheral module 200 that the barcode has been processed successfully and information about the item comprising the barcode scanned by the code scanner 220.

### Ack(sMessageID)

This function sends a confirmation message to the central module 100 referring to a specific message code identifier sMessageID. In this way, the peripheral module 200 can inform the central module 100 that it has received the message/request/command including this message code identifier.

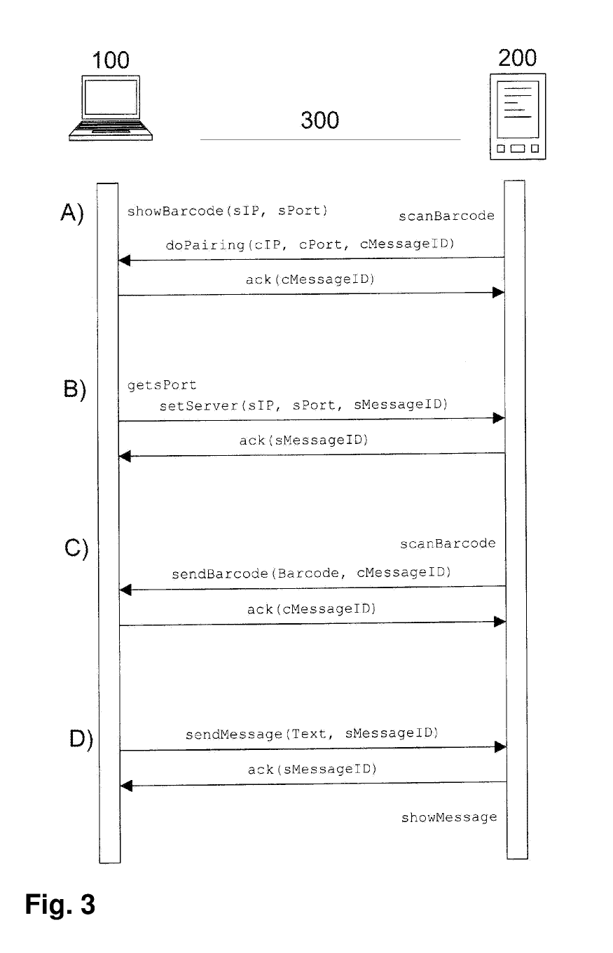

Referring now to FIG. 3, some communication procedures of the system of the invention are explained in more detail.

For a pairing process A, the following assumptions should be considered in this example. The peripheral module 200 has never been connected to the central module 100 before. The central module 100 has been restarted and has dynamically been allocated the IP address 192.168.1.100, wherein the first ports No. 49152-49154 of the central module 100 are already used by other applications. The peripheral module 200 is restarted and dynamically gets the IP address 192.168.2.100, wherein the unique port No. 50000 is permanently reserved for the use of wireless communication with a central module.

a) The pairing process is initiated by pressing a button of the inputting device 140 of the central module 100.

b) The function getsPort( ) of the first application running on the processing device 110 of the central module 100 determines a first communication port 120′ out of the first ports 120 of the central module 100 being currently available and reserves it for the communication with one or more peripheral modules 200. In this example, the first communication port 120′ has been allocated the port No. 49155.

c) Next, the function showBarcode( ) is called up. This function displays a barcode having the symbolism of a data matrix on the display 130 of the central module 100 having the following contents: doPairing#192.168.1.100:49155.

d) This barcode is read by the code scanner 220 of the peripheral module 200. Since the barcode starts with doPairing# (or after a more detailed inspection using regular expressions) the processing device 210 of the peripheral module 200 stores the settings sIP=192.168.1.100 and sPort=49155 in the memory 240.

e) Now, a pairing request is transmitted from the peripheral module 200 to central module 100. For this, first a message code identifier cMessageID=1001 is generated (or retrieved from a sequencer). Then, the communication data of the peripheral module 200 are transmitted to the known first communication port 120′ of the central module 100 by sending doPairing(192.168.2.100,50000,1001).

f) The first communication port 120′ of the central module 100 receives this message from the peripheral module 200. The processing device 110 of the central module 100 then stores the communication data cIP=192.168.2.100 and cPort=50000 in the memory 150 as explained above.

By storing this communication data of the peripheral module in a main table it is possible to ensure that a former connection of the peripheral module 200 may disconnected if established.

g) For confirming safe receipt of the pairing request from the peripheral module 200, the central module 100 transmits the message ack(1001) back to the peripheral module 200.

h) In addition, the central module 100 may also send a confirmation text by using the function sendMessage(“Pairing successful”, 1002) to the peripheral module 200 (procedure D in FIG. 3). The peripheral module 200 can confirm safe receipt of this message by sending the conformation message ack(1002) back to the central module 100.

Referring still to FIG. 3, a variant B of the above pairing procedure of the system of the invention is explained in more detail. The following assumptions should be considered in this example. The peripheral module 200 has already been connected to the central module 100 before. The central module 100 is restarted and is dynamically allocated the IP address 192.168.1.110, wherein the first ports No. 49152-49159 of the central module 100 are already used by other applications. The IP address cIP and the port No. cPort of the peripheral module 200 are stored in the memory 150 of the central module 100. The peripheral module 200 is restarted and has the fixed IP address 192.168.2.100 and the unique port No. 50000.

a) First, the function getsPort( ) determines a currently available first port as the first communication port 120′. In this example, the port No. 49160 is allocated to this first communication port 120′.

b) Then, optionally communication data sIP and sPort of the first communication port 120′ central module 100 are transmitted to the second communication port 230 of the peripheral module 200 having the stored communication data cIP and cPort by the function setServer(192.168.1.110,49160,1011).

c) Afterwards, the peripheral module 200 can confirm safe receipt of the communication data by transmitting ack(1011) to the central module 100.

d) Finally, in a procedure D, the central module 100 can send a confirmation text to the peripheral module 200 using the function sendMessage(“Pairing successful”, 1012). The peripheral module 200 can display the message on the display 250, and optionally confirm safe receipt of the confirmation text by transmitting ack(1012) to the central module 100.

In normal operation, i.e. after having performed one of the above pairing procedures A or B successfully, barcodes can be scanned by the peripheral module 200 and transmitted to the central module 100 according to procedure C in FIG. 3.

a) First, a scanning process is initiated by pressing the scanner button of the inputting device 260 of the peripheral module 200 and calling up the function scanBarcode( )

b) Then, the barcode scanned by the code scanner 220 is pre-processed by the processing device 210 of the peripheral module 200 and transmitted from the second communication port 230 of the peripheral module 200 to the central module 100 by the function sendBarcode(Barcode,cMessageID).

c) The processing device 110 of the central module 100 recognizes that the data received by the first communication port 120′ include a barcode scanned by the peripheral module 200. After processing the received barcode data, the central module 100 can confirm safe receipt of the barcode data by transmitting ack(cMessageID) back to the peripheral module 200.

Next, different procedures for various operating states of the central module 100 and the peripheral module 200 are explained.

### 1) Both Modules Active

In case both modules 100, 200 are active, the connection via WLAN should be ready to use. When scanning a barcode by the code scanner 220, the barcode is transmitted to the central module 100 and the receipt is acknowledged to the peripheral module 100. When transmitting messages from the central module 100 to the peripheral module 200, these are displayed on the display 130 and acknowledged immediately.

### 2) Central Module Active, Peripheral Module Inactive

For scanning a barcode, the peripheral module 200 is awakened from its standby state, and the second communication port 230 of the peripheral module 200 uses the communication data sID and sPort of the first communication port 120′ stored in the memory 240.

When the central module 100 transmits a message to the peripheral module 100, however, the central module 100 would receive no corresponding confirmation message. After a preset timeout, a message is displayed on the display 130 of the central module 100 that the peripheral module 200 is not accessible.

### 3) Central Module Inactive, Peripheral Module Active

After scanning a barcode by the code scanner 220, the peripheral module 200 tries to send the scanned barcode to the central module 100. Since the peripheral module 200 will receive no confirmation message form the inactive central module 100 within a preset timeout, the processing device 210 will display an error message on the display 250 of the peripheral module 200.

1-10. (canceled)

11. A system for communicating data between a central module and at least one peripheral module, the system comprising:
a central module including:
at least one first port that transmits and receives data; and
a display that displays a first port identification code identifying a first communication port from among the at least one first port, the first communication port being currently available to transmit and receive data;
at least one peripheral module including:
a code scanner that scans the first port identification code displayed on the display of the central module; and
a second port defining a second communication port that transmits and receives data and including a second port identification code; wherein
the at least one peripheral module transmits the second port identification code to the first communication port of the central module via the second communication port.

12. The system according to claim 11, wherein the first communication port of the central module and the second communication port of the at least one peripheral module communicate in a wireless manner.

13. The system according to claim 11, wherein the central module determines that the first communication port from among the at least one first port, receives the second port identification code of the at least one peripheral module via the first communication port, and transmits data to the second communication port of the at least one peripheral module via the first communication port.

14. The system according to claim 11, wherein the central module includes or is connected to a memory that stores the first port identification code of the central module and the second port identification code of the at least one peripheral module.

15. The system according to claim 11, wherein the first port identification code includes data referring to an IP address of the central module and data referring to the first communication port of the central module and/or the second port identification code includes data referring to an IP address of the at least one peripheral module and data referring to the second communication port of the at least one peripheral module.

16. The system according to claim 11, wherein the first port identification code includes instruction data indicating that the first port identification code is associated with the central module which the at least one peripheral module is to communicate with, and/or the second port identification code includes instruction data indicating that the second port identification code is associated with the at least one peripheral module which the first communication port of the central module is to communicate with.

17. The system according to claim 11, wherein the central module transmits acknowledgement data to the at least one peripheral module acknowledging successful receipt of data from the at least one peripheral module and/or the at least one peripheral module transmits the acknowledgement data to the central module acknowledging successful receipt of data from the central module.

18. The system according to claim 11, wherein the code scanner is provided in a peripheral module that is capable of being used in the system.

19. The system according to claim 11, wherein the display is provided in a central module that is capable of being used in the system.

20. A method for communicating data between a central module and a peripheral module, the method comprising the steps of:
determining a first communication port from among at least one first port of the central module, the first communication port being currently available to transmit and receive data;
displaying a first port identification code identifying the first communication port on a display of the central module;
scanning the first port identification code displayed on the display of the central module by the peripheral module; and
transmitting a second port identification code identifying a second communication port of the peripheral module from the second communication port of the peripheral module to the first communication port of the central module.
